(19) United States
(12) Patent Application Publication
(10) Pub. No.: US 2012/0160988 A1
(43) Pub. Date: Jun. 28, 2012

(54) FOLDABLE ELECTRONIC DEVICE HAVING HEIGHT-ADJUSTABLE KEYPAD

(75) Inventors: WEI WU, Shenzhen City (CN); XIN YANG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/220,608

(22) Filed: Aug. 29, 2011

(30) Foreign Application Priority Data
Dec. 28, 2010 (CN) 201010609678.1

(51) Int. Cl. G06F 3/02

(52) U.S. Cl. 248/685

(57) ABSTRACT

A foldable electronic device includes a base defining a chamber, and a cover pivotably connected to the base. The electronic device further includes a keypad including a first end pivotably connected to the cover, and a second end moveably received in the chamber. During opening and closing of the cover, the first end of the keypad moves together with the cover and the second end slides in the chamber, thereby changing a space between the keypad and the base.

### BACKGROUND

1. Technical Field

The present disclosure relates to a foldable electronic device with a height-adjustable keypad.

2. Description of Related Arts

Many notebook computers include a keyboard directly installed on its main body. The keyboard cannot be adjusted to a desired angle for use. As a result, the keyboard is not ergonomic, and tends to cause fatigue in users.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a foldable electronic device in accordance with an exemplary embodiment.

FIG. 2 is an isometric, exploded view of the foldable electronic device of FIG. 1.

FIG. 3 is similar to FIG. 2, but viewed from a different viewpoint.

FIG. 4 is a planar, cross-sectional view of the foldable electronic device of FIG. 1, showing a cover in a closed position.

FIG. 5 is similar to FIG. 4, but showing the cover in an open position.

### DETAILED DESCRIPTION

Embodiments of the present disclosure will now be described in detail below, with reference to the accompanying drawings.

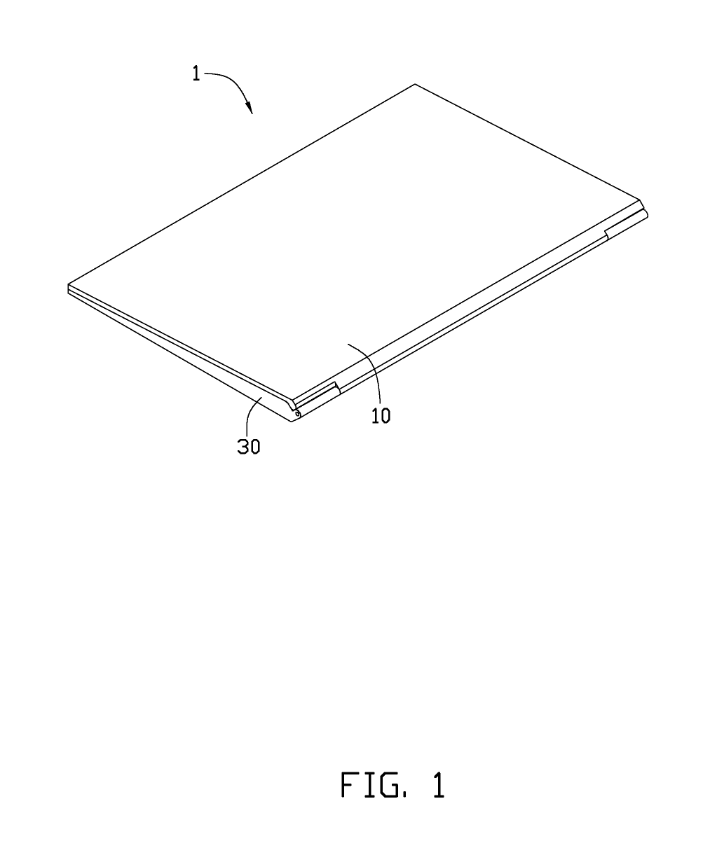

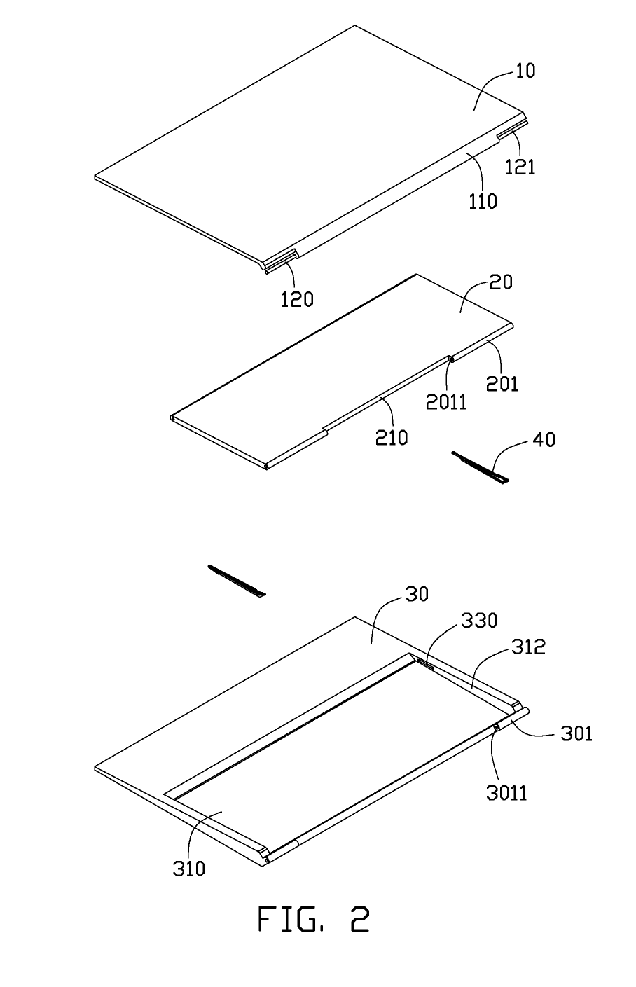

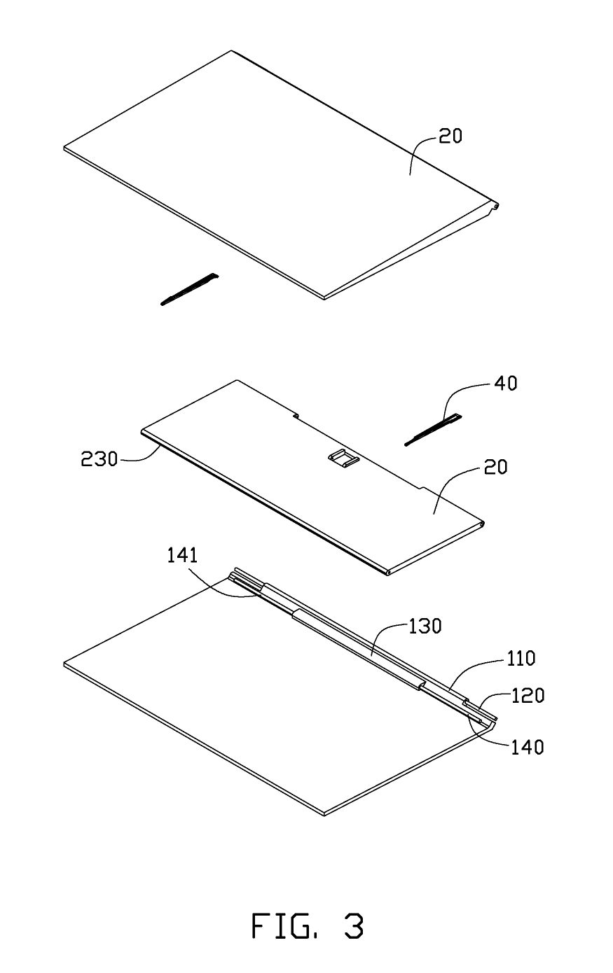

Referring to FIGS. 1-3, a foldable electronic device 1 includes a cover 10, a keypad 20, and a base 30. One end of the cover 10 is pivotably connected to the base 30. The base 30 further defines a chamber 310 to receive the keypad 20. A front end 210 of the keypad 30 is pivotably connected to the cover 10.

In the embodiment, an elongated protrusion 110 protrudes from a front end of the cover 10. An axle 120 extends along the lengthwise direction of the cover 10 and includes two portions 121 protruding from opposite ends of the protrusion 110. The base 30 includes two ears 301 protruding from its front end. Each ear 301 defines a through hole 3011. The two portions 121 of the axle 120 are rotatably received in the through holes 3011, thereby rotatably connecting the cover 10 to the base 30.

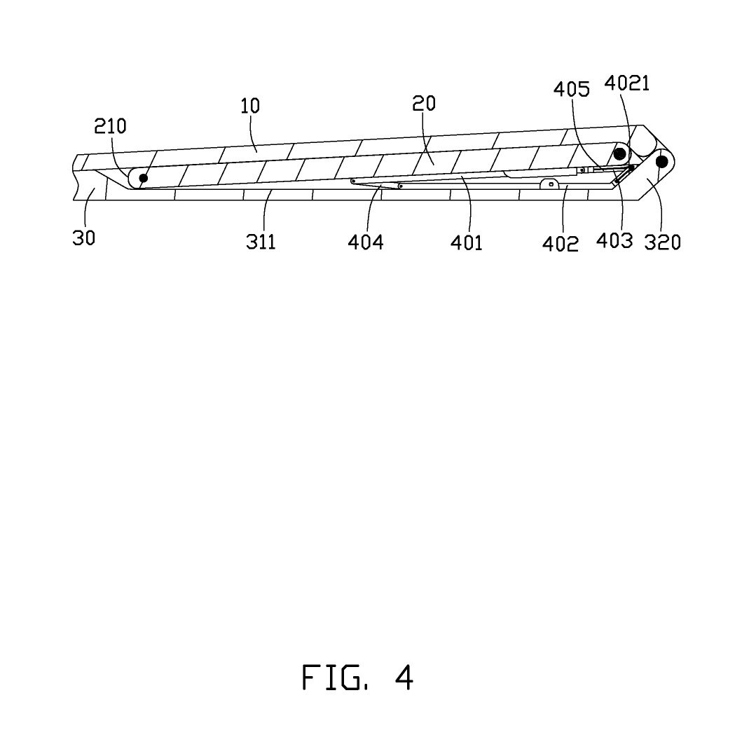

In the embodiment, two axle holding portions 201 protrude from the front end 210. Each axle holding portion 201 defines a through hole 2011. The cover 10 further includes an elongated protrusion 130 protruding from its inner surface. An axle 140 extends along the lengthwise direction of the cover 10 and includes two portions 141 protruding from opposite ends of the protrusion 130. The two portions 141 are rotatably received in the through holes 2011, thereby rotatably connecting the key pad to the cover 10. A rear end 230 (FIG. 4) movably resides on the bottom 311.

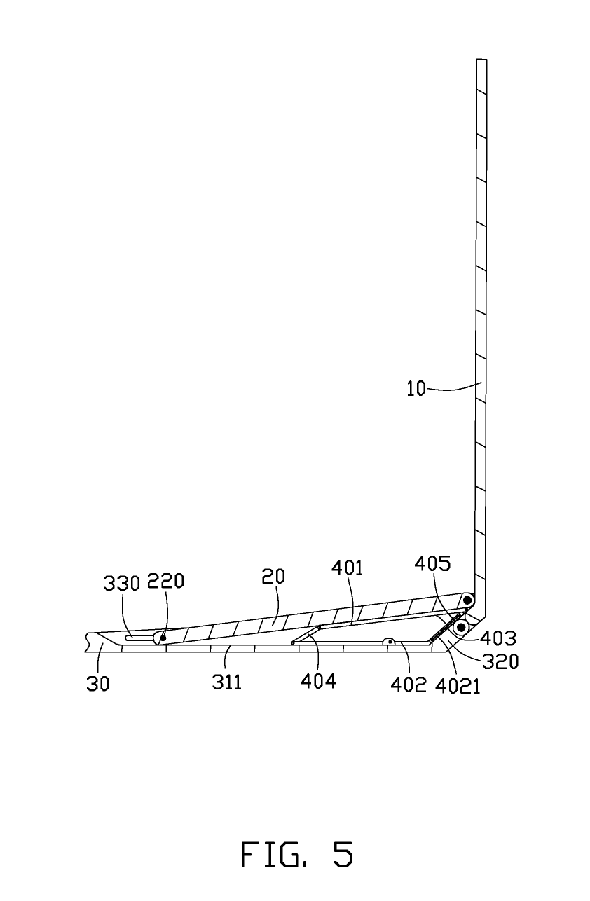

Referring to FIGS. 4 and 5, the electronic device 1 further includes two support assemblies 40 under the keypad 20 at opposite sides thereof. In the embodiment, each support assembly 40 includes four linkage bars 401, 402, 403, and 404. The linkage bar 401 is fixed to a back side of the keypad 20 that opposes the base 30. The linkage bar 402 is fixed to the base 30 opposite the linkage bar 401. Two opposite ends of the linkage bar 401 are rotatably connected to first ends of the linkage bars 403 and 404, and two opposite ends of the linkage bar 402 are rotatably connected to second ends of the linkage bars 403 and 404, thereby forming a four-bar linkage mechanism. In an alternative embodiment, the number of the support assemblies 40 may be varied according to need.

Each support assembly 40 further includes an elastic member 405. In the embodiment, the elastic member 405 is a substantially straight metal wire. A portion of the elastic member 405 is fixed to and extends along an inclined portion 4021 of the linkage bar 402, while the other portion of the elastic member 405 is fixed to and extends along the linkage bar 403. As shown in FIG. 4, when the cover 10 is closed, the elastic member 405 is bent.

During opening of the cover 10, the front end 210 of the keypad 20 moves together with the cover 10. As the keypad 20 moves, the elastic member 405 starts to rebound and provides a pushing force on the keypad 20. When the cover 20 is rotated to a position as shown in FIG. 5, the elastic member 405 returns to its original shape. The linkage bar 403 abuts against an inclined portion 320 of the base 30 where the inclined portion 4021 of the linkage bar 402 is arranged, which prevents the keypad 20 from further movement. Due to the pushing force from the two elastic members 405, the keypad 20 can maintain the inclined orientation in FIG. 5. The inclined orientation of the keypad 20 allows users to be more comfortable when using the keypad 20. In addition, when the keypad 20 is inclined as in FIG. 5, the space between the keypad 20 and the base 30 is larger, which can enhance the dispassion of heat.

In the embodiment, two rotary joints 220 are respectively, rotatably connected to opposite sides of the rear end 230. The base 30 further defines two slots 330 in opposite sidewalls of the chamber 310. Each rotary joint 220 includes an end slidably received in one slot 330. When the keypad 20 moves, each rotary joint 220 is guided by the slot 330, allowing the rear end 230 to slide on the bottom 311.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. A foldable electronic device comprising:
a base defining a chamber;
a cover pivotally connected to the base;
a keypad comprising a first end pivotally connected to the cover, and a second end moveably received in the chamber, wherein during opening and closing the cover, the first end of the keypad moves together with the cover and the second end sliding in the chamber, thereby changing a space between the keypad and the base.

2. The foldable electronic device according to claim 1, further comprising two support assemblies, wherein each support assembly comprises a first linkage bar, a second linkage bar, a third linkage bar, and a fourth linkage bar that are rotatably connected to each other in sequence, the first linkage bar is fixed to the keypad, the second linkage bar is fixed to the base opposite the first linkage bar, the base comprises a first inclined portion, the second linkage bar comprises a second inclined portion fixed on the first inclined portion, when the cover is rotated to a predetermined position, the third linkage bar abuts against the first inclined portion and is aligned with the second inclined portion, thereby preventing the cover from further rotating.

3. The foldable electronic device according to claim 2, wherein each support assembly further comprises an elastic member, a portion of the elastic member is fixed to and extends along the second inclined portion of the second linkage bar, the other portion of the elastic member is fixed to and extends along the third linkage bar, when the cover is rotated to a predetermined position, the elastic member applies a push force to the first linkage bar.

4. The foldable electronic device according to claim 3, wherein the elastic member is a metal wire.

5. The foldable electronic device according to claim 1, wherein the base further defines two slots in opposite sidewalls of the chamber, the second end of the keypad comprises two rotary joint rotatably connected thereto, each rotary joint is slidably received in one slot.

6. A foldable electronic device comprising:
a base defining a chamber and comprising a first inclined portion;
a cover pivotally connected to the base;
a keypad comprising a first end pivotally connected to the cover, and a second end moveably received in the chamber; and
at least one support assembly comprising a first linkage bar, a second linkage bar, and a third linkage bar, wherein the first linkage bar is fixed to the keypad, the second linkage bar is fixed to the base opposite the first linkage bar, the third linkage bar comprises two ends rotatably connected to the first linkage bar and the third linkage bar, the second linkage bar comprises a second inclined portion fixed on the first inclined portion, when the cover is rotated to a predetermined position, the third linkage bar abuts against the first inclined portion and is aligned with the second inclined portion, thereby preventing the cover from further rotating.

7. The foldable electronic device according to claim 6, wherein the number of the at least one support assembly is two.

8. The foldable electronic device according to claim 6, wherein each support assembly further comprises an elastic member, a portion of the elastic member is fixed to and extends along the second inclined portion of the second linkage bar, the other portion of the elastic member is fixed to and extends along the third linkage bar, when the cover is rotated to a predetermined position, the elastic member applies a push force to the first linkage bar.

9. The foldable electronic device according to claim 8, wherein the elastic member is a metal wire.

10. The foldable electronic device according to claim 6, wherein the base further defines two slots in opposite sidewalls of the chamber, the second end of the keypad comprises two rotary joint rotatably connected thereto, each rotary joint is slidably received in one slot.
